(19) United States
(12) Patent Application Publication
(10) Pub. No.: US 2013/0130093 A1
(43) Pub. Date: May 23, 2013

(54) ALKALINE BATTERY SEPARATORS WITH ION-TRAPPING MOLECULES

(71) Applicant: The Gillette Company, Boston, MA (US)

(72) Inventors: Yichun Wang, Bethel, CT (US); Tatjana Mezini, Bethel, CT (US); AnnaMaria Bofinger, Shoreview, MN (US); Javit A. Drake, Boston, MA (US); Paul A. Christian, Bethel, CT (US)

(73) Assignee: THE GILLETTE COMPANY, Boston, MA (US)

(21) Appl. No.: 13/741,840

(22) Filed: Jan. 15, 2013

Related U.S. Application Data
(62) Division of application No. 12/621,598, filed on Nov. 19, 2009.

(51) Int. Cl. H01M 2/16; H01M 2/14

(52) U.S. Cl. CPC H01M 2/16; H01M 2/145
USPC 429/145; 427/58

(57) ABSTRACT

Battery separators are disclosed which include an ion selective polymeric film, composite film, or multi-layer containing an immobilized chelating agent.

### FIELD OF THE INVENTION

This invention relates to alkaline battery separators with ion-trapping molecules.

### BACKGROUND OF THE INVENTION

Several cathode chemistries of high energy density and/or rate capability (e.g., Bi-oxides, Cu-oxides, oxides of high valence state Fe, oxides of high valence state Mn) exhibit limited shelf-life due to self-discharge when configured into batteries with alkaline electrolyte. Examples of such electrolytes include potassium hydroxide, sodium hydroxide, lithium hydroxide, or combinations thereof. Self-discharge can render the voltage of a cell containing the chemistry unacceptably low, or make the cell capacity negligible, sometimes within days.

Attempts have been made to address this problem using conventional separators, and using separators that are modified for ion selectivity, i.e., conduction of hydroxide ions with blockage of metal ion or metal-ion complexes. Modified battery separators can include one or more ion-trapping layers. The ion-trapping layer can convert a soluble metal, for instance, a bismuth ionic species, into bismuth metal or a bismuth-complexed species of reduced solubility or mobility in the electrolyte. This conversion takes place via a chemical reaction or ionic bond. Another example involves a silver oxide cathode adjacent to a two-layer separator includes cellophane and a non-woven layer. The cellophane layer with its surface functionality sacrificially reduces Ag⁺ or Ag⁺² to silver metal preventing transport to the anode. Alternatively, the ion-trapping layer can include organic compounds such as metal sequestering agents, chelating agents, and complexing agents. Such compounds include, for example, cyclodextrin compounds and linear chain polyols including, for example, xylitol, that are stable in alkaline electrolyte solutions. Such organic metal ion-complexing compounds are in some cases grafted or otherwise bonded to a polymeric substrate that is stable and insoluble in the electrolyte. Such grafted polymers have been applied as a coating to a non-woven layer or to a permeable or semi-permeable membrane.

### SUMMARY OF THE INVENTION

The present disclosure features separators that contain chelating agents to capture cathodic metal ions, thereby improving the shelf life of alkaline batteries containing the separators. The separators disclosed herein are beneficial, for example, for chemistries that suffer from shelf-life limitations due to electrolyte-soluble cathodes, such as CuO, Bi₂O₃, and metal oxides containing pentavalent bismuth.

In one aspect, the disclosure features a battery separator that includes a polymeric film and a chelating agent immobilized in the polymeric film. The battery separator has a Gurley number greater than 100, such as, for example, greater than 1,000.

In another aspect, the disclosure provides a battery separator that includes two nanoporous layers and a chelating layer between the two nanoporous layers. The chelating layer can include a chelating agent capable of forming a complex with cathodic metal ions.

In a further aspect, the disclosure features a battery separator that includes a polymeric film and a chelating agent comprising HEDTA that is immobilized in the polymeric film.

In an additional aspect, the disclosure provides a method of making a battery separator. The method includes immobilizing a chelating agent in a polymeric matrix, and forming a film from the polymeric matrix containing the chelating agent.

In another aspect, the disclosure features a method of making a battery separator. The method includes disposing a chelating-agent-containing layer between two nanoporous layers.

Embodiments can include one or more of the following features.

The battery separator can be substantially impermeable to fluid flow.

The chelating agent can include a cyclodextrin.

The chelating agent can include a derivative of EDTA. For example, the EDTA derivative can be selected from CDTA, HEDTA, TTHA, EGTA, DTPA, NTA, and mixtures thereof. In some embodiments, the EDTA derivative is HEDTA.

A concentration of chelating agent in the polymeric film can be at least 0.1 μg per square centimeter of geometric surface area of the battery separator.

The polymer of the battery separator can be selected from polyacrylic acid, polyvinyl alcohol, polycellulose, polystyrene sulfonate, and mixtures thereof.

The two nanoporous layers can have pores larger than a size of hydrated hydroxide ion and smaller than a size of the chelating agent and complex.

The battery separator can include a slurry, solution, or suspension, and the slurry, solution or suspension can include the chelating agent in a carrier.

Immobilizing can include mixing the chelating agent with a polymer.

Immobilizing can include reacting the chelating agent with a polymer.

Reacting can include covalently bonding the chelating agent to the polymer.

Immobilizing can include first reacting the chelating agent with a material to form a reaction product and subsequently blending the reaction product with a polymer.

Reacting can include bonding the chelating agent to a larger substrate molecule.

The material can be selected to increase the water solubility of the chelating agent.

The method can further include forming the chelating layer by forming a solution, dispersion or slurry of a chelating agent in a carrier.

The separators disclosed herein may exhibit one or more of the following advantages. The separator may exhibit good selectivity at high alkalinity, may reduce the oxidation state of metal ions, may be able to capture effectively and retain metal ions from solution, and may maintain its ion-trapping ability in highly alkaline electrolyte.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a schematic diagram showing a battery containing separator a layer where metal ion chelating agents are trapped between nanoporous layers.

FIG. 1A is an enlarged detail view of the portion of the separator circled in FIG. 1. FIG. 2 shows light absorption spectra of 0.9 M KOH solutions (pH 13.9) containing 0.35 mM (21 ppm) Cu²⁺, and 1.8 mM β-cyclodextrin with varying concentrations of HEDTA.

FIG. 3 shows light absorption spectra of 5.1 M KOH solutions containing 1.9 mM (100 ppm) Cu²⁺, 9 mM β-cyclodextrin with varying concentrations of HEDTA.

FIG. 4 shows light absorption spectra of 9 M KOH solutions containing 3.4 mM Cu²⁺ (160 ppm), 16 mM β-cyclodextrin with varying concentrations of HEDTA.

### DETAILED DESCRIPTION OF THE INVENTION

Preferred ion selective separators and fabrication methods for such separators are described below. The separators contain immobilized chelating agents. In some implementations, the separators are formed by reacting and/or blending a polymer with a chelating agent to create a polymeric film containing an immobilized chelating agent. In certain implementations, the chelating agent is immobilized between two nanoporous layers. Optionally, these approaches may be combined. In both cases, the chelating agent is effectively immobilized, while maintaining the ability of the chelating agent to capture metal ions.

Some of the preferred separators disclosed herein include a continuous layer, e.g., of substantially low flow permeability that has a high concentration of chelating agent.

A separator may be determined to have low permeability to fluid flow by its Gurley number or Gurley units. Namely, a high Gurley number indicates that a separator has low flow permeability. The continuous, e.g., substantially low-flow-permeability, separator layers disclosed herein can have Gurley numbers greater than 100, such as greater than 1,000, unlike porous paper and non-wovens (such as described in U.S. Pat. No. 6,613,703). Gurley Precision Instruments, Troy, N.Y., has prescribed procedures and instruments, such as Model 4150. The Gurley unit standard of permeability is defined in E Cardarelli, Encyclopaedia of Scientific Units, Weights and Measures, p. 363, Springer-Verlag (2003). While not wishing to be bound by theory, it is believed that a substantially continuous layer can force metal ions within molecular-scale proximity to the chelating agent located in the layer.

Generally, the concentration of chelating agent is at least 0.1 μg/cm² (expressed in mass of chelating agent per geometric surface area of separator). Optionally, the concentration of chelating agent is 0.1 g/cm² (expressed in mass of chelating agent per geometric surface area of separator).

By “ion selective,” we mean that the separators disclosed herein are able to complex with and reduce migration of metal ions, such as Cu²⁺ and Bi³⁺, while allowing permeation of hydroxide ions.

There are several ways to incorporate a chelating agent, e.g., cyclodextrin, into separators for high energy alkaline batteries. The chelating agent can be physically mixed with a polymer matrix, or chemically reacted to cause molecular incorporation of the chelating agent into a polymer matrix.

Physical mixtures can be accomplished, for example, by mixing the chelating agent with polyacrylic acid, polyvinyl alcohol, or other polymers typically used in alkaline battery separators. For example: a mixture of cyclodextrin, polyacrylic acid and cellulose acetate in methyl ethyl ketone can be prepared in a homogenous solution with stirring of several hours at room temperature. The ratios of different components in the mixture can be varied. Other polymers such as polyvinyl alcohol can also be formulated with cyclodextrin into a solution. Polyvinyl alcohol and hydroxylpropyl-beta-cyclodextrin can be prepared in a water solution at 60 to 80° C. for overnight. The ratios of two components can be varied for suitable viscosity in preparation of separator film.

The solution can be used to cast a film in a thickness of 5 to 40 mils. The film can then be used as a separator either in itself or in combination with cellophane.

Molecular incorporation of the chelating agent into a polymer matrix can be accomplished, for example, by covalently bonding the chelating agent to one or more polymers or monomers. As an example, polymers such as cellulose, polyacrylic acid, and maleic anhydride can be covalently bonded with cyclodextrin. In the case of EDTA derivatives, the chelating agent can first be reacted to a larger immobile substrate. For instance, the chelating may be covalently bonded to a carboxy-functionalized microsphere. Most cyclodextrin molecules are not water soluble. However, the combination of cyclodextrin with other water soluble polymers offers a practical benefit in preparation of separator film. The incorporation of cyclodextrin into a polymer matrix creates a more water soluble and more easily prepared separator film. Optionally, the larger substrate (microsphere) may be contained in the separator by non-bonding means, such as a nanoporous membrane. In some embodiments, a larger molecule can be used which has functionality to further bond. However, even if not bonded, the use of a large molecule can increase the likelihood of confinement by a nanoporous membrane. Alternatively, to preserve all of nucleophilic groups for chelation, covalent bonding to a polymer via one or more carbon atoms may be preferred. In some cases, it may be desirable to react the chelating agent with a material that increases the water solubility of the chelating agent, so that the reaction product can then be blended with a polymer in aqueous solution.

For example, cyclodextrin can be covalently bonded with epichlorohydrin in a sodium hydroxide solution. This water soluble cyclodextrin polymer can further be attached to polyvinyl alcohol as well as polyacrylic acid.

The blended polymer mixtures or bonded polymer matrices can be cast or extruded as a film. Separators of different thicknesses can be obtained, for example, by controlling the parameters of solution casting or extruding, and/or by lamination with other layers, e.g., non-woven materials. These films can be prepared to a thickness of, for example, from 5 to 40 mils.

The ion selective films should generally be stored under slight compression between flat dry surfaces (e.g., paper with weight) to avoid the film's tendency to roll. Also, to avoid the tendency to absorb ambient moisture and become sticky, the film should generally be stored in a dry environment until tested or inserted to a battery.

In one embodiment, an ion selective film may be made using β-cyclodextrin (CD) as the chelating agent by (a) solution phase mixing of CD and a polymer, (b) casting the resulting mixture into a separator film, and (c) drying to remove solvent.

Examples of suitable chelating agents will now be discussed.

### Chelating Agents

A) Cyclodextrins

Cyclodextrins are cyclic oligomers consisting of 6, 7, or 8 α-1,4-linked glucose monomers. Structurally, cyclodextrins are torus-shape molecules. Cavities within the cyclodextrin molecules capture guest molecules or metal ions that can be captured, forming a stable complex. It is well documented that β-cyclodextrin can strongly complex metal ions such as Cu²⁺, Pb²⁺, Co²⁺, Mn³⁺, Cd²⁺ in alkaline solutions. Other cyclodextrins, such as α and γ-cyclodextrins have very similar properties as β-cyclodextrin. Cyclodextrins can be derivatized through the hydroxyl groups with many other polymers or molecules. The derivatized cyclodextrins can have many desirable chemical and physical properties. For example, α-hydroxylpropyl β-cyclodextrin can be one of those derivatives of cyclodextrins. It has desirable properties, such as water solubility.

B) Derivatives of Ethylenediaminetetraacetic Acid (EDTA)

A class of chelating agents similar to ethylenediaminetetraacetic acid (EDTA) also capture metal ions in strongly alkaline solutions. Some chelating agents within this class are:

trans-cyclohexane-1,2-diaminetetraacetic acid (CDTA)

hydroxyetylethylenediaminetriacetic acid (HEDTA)

triethylenetetraaminehexaacetic acid (TTHA)

ethylenedioxydiethylenediaminetetraacetic acid (EGTA)

diethylenetriaminepentaacetic acid (DTPA)

nitrilotriacetic acid (NTA)

EGTA and CDTA chelate Cu²⁺ up to pH 13.3 and 14.2 respectively. No limitation in chelating activity through pH 14.3 was detected for TTHA and HEDTA. (For reference, a pH of 14.3 can be produced by solutions of about 2 to 3 M OH⁻ depending upon the additional ions present.)

Applicants have found that HEDTA captures Cu²⁺ metal ions at up to 5 M, and potentially up to 9 M, KOH concentrations. The importance of the discovery is that such highly alkaline electrolyte is necessary for a significant number of commercial alkaline batteries.

### Confinement of Chelating Agent in Nanoporous Layers

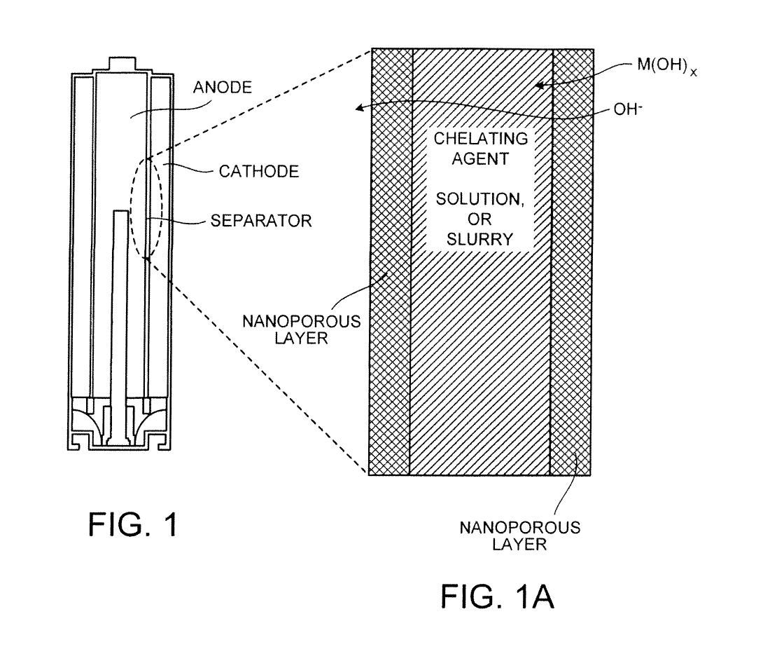

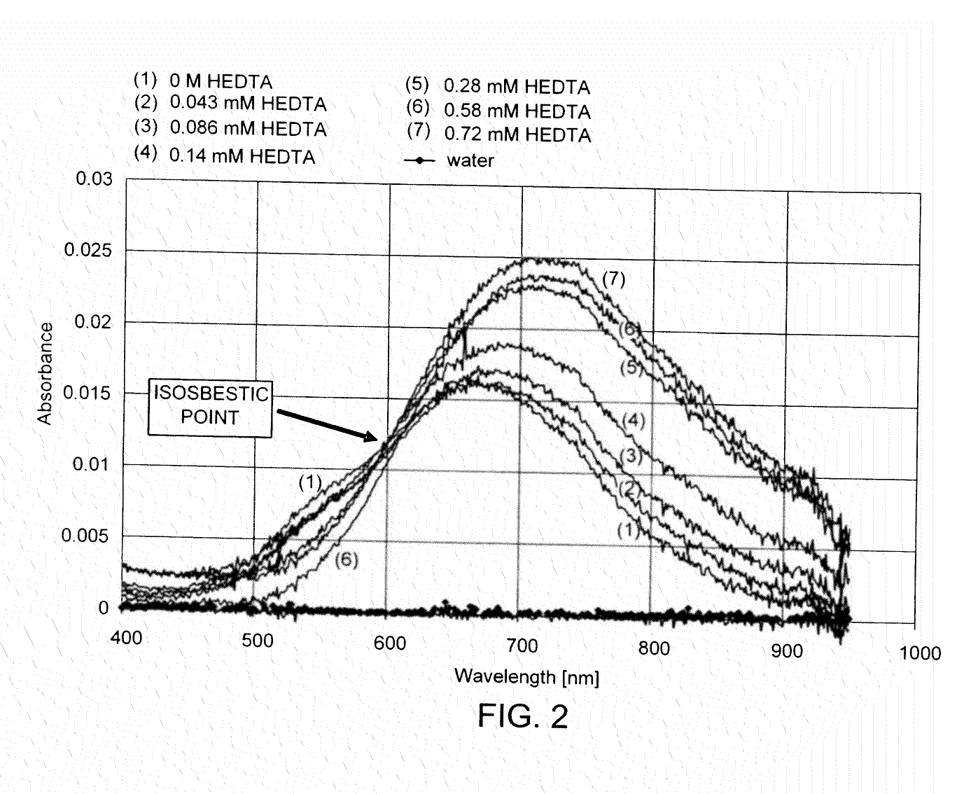

Chelating agents can be contained in multiple layers within the separator. An embodiment of a such separator is shown in FIGS. 1 and 1A. Such separators can be formed by a variety of methods. For example, in some implementations a layer of chelating agent in solution, suspension, or slurry is sandwiched between two nanoporous layers. Water can be used as the carrier. The concentration of chelating may be, for example, from 0.1 μg/cm² to 0.1 g/cm² (expressed in mass of chelating agent per geometric surface area of separator). The chelating agent within the aqueous alkaline layer may be as concentrated as possible while maintaining ability to transport of OH⁻ ions. In some embodiments, the layer can be a (porous) packed layer of solid chelating agent particles with alkaline solution (<0.1 g/cm²). In certain embodiments, the layer can be a saturated or sub-saturated homogeneous liquid of chelating agent dissolved (>0.1 ug/cm²) in alkaline solution. In general, the nanoporous layers have pores smaller than the size of the chelating agent molecule, which can prevent the chelating agent from moving out from between the nanoporous layers. The water and hydroxide may be free to move through layers. The chelating agent and hence the complexed metal ion would typically be bounded within the nanoporous layers. A “chelating layer” contains chelating agent as a solid or in solution.

As shown in FIG. 1A, the nanoporous layers permit the transport of hydroxide ion (OH⁻) from the cathode to the anode, but prevent the transport of the chelating agent and chelate-metal ion complex. As shown, the metal ion complex, M(OH)ₓⁿ, from the cathode may permeate the nanoporous layer adjacent to the cathode, but it is then captured in the chelating layer and prevented from passing through the nanoporous layer adjacent the anode. Advantages of this approach over films with immobilized chelating agent can be in preparation (fabrication) and high density of chelating agent. In some cases, this physical restriction (size exclusive confinement) of the chelating agent may be easier (less costly, more reliable) than covalently bonding to immobilized substrate or separator polymer. The density of chelating agent is up to ˜0.1 g/cm², the density of the powdered solid. This high loading can enhance the capacity and contact of metal ions with chelating agent.

The nanoporous layers should generally have pores larger than the size of hydrated hydroxide ion and smaller than the size of the chelating agent and complex, and stability in a highly alkaline solution.

Nanoporous layers of the desired pore size range and stability in high alkalinity are commercially available through Koch Membrane Systems (Wilmington, Mass.) and Somicon (Basel, Switzerland). As a measure of pore size, layers are rated according to the maximum molecular weight of molecules allowed to permeate. The chelating agents HEDTA and β-cyclodextrin have molecular weights of 278 and 1135 g/mol, respectively. Appropriately, Somicon offers layers that are impermeable to sizes >200-250 g/mol and able to withstand 15% NaOH at 60° C. SelRO® membranes by Koch also have size restrictions in the range desired and high alkaline stability. In particular, the product designated as MPF-34 rejects species greater than 200 g/mol, has a thickness of roughly 10 mil (including an additional support layer), and stability through at least pH 14 Important for battery function is that water (18 g/mol) and hydrated hydroxide ions (˜65 g/mol) easily permeate these commercial nanoporous layers. It is to be noted that pore size can be important to containing the larger chelating molecule vs. water and hydroxide. Porosity may be a secondary factor. In general, higher porosity may be preferred (e.g., >50%, e.g., >75%) for facilitating hydroxide transport.

### EXAMPLES

### Example I

Chelating agent (β-cyclodextrin) was polymerized into a film using an aqueous preparation method. β-cyclodextrin, which is substantially insoluble in water, was initially reacted with epichlorohydrin to create a water-soluble cyclodextrin (CD) polymer. A β-cyclodextrin was stirred in a solution of 33% NaOH for overnight at room temperature. Epichlorohydrin was rapidly added into the stirred mixture. The mixture was stirred again for several hours before acetone was added. After an aqueous layer was removed, the mixture pH was adjusted to neutral. The white CD polymer was collected from the filtration. The molar ratio of CD to epichlorohydrin can be varied from 1:5 to 1:15. Next, to create a polymer blend that could be film cast, the CD solution was mixed with a styrene sulfonate-acrylic acid polymer. A solution of polystyrenesulfonate and polyacrylic acid produced from polymerization of styrene and acrylic acid was mixed with a CD polymer obtained from the aforementioned procedure. The overall ratio of PAA, PSS and CD could be 50:30:20; 40:40:20; 20:30:50, or 22:40: 40 or other ratios. The polymer solution was then film cast, resulting in an ion selective film having a thickness of 5 to 40 mils.

In another experiment, water-soluble α-hydroxylpropyl β-cyclodextrin was mixed with polyvinyl alcohol in water. One example is a mixture of 30% α-hydroxylpropyl β-cyclodextrin and 7% polyvinyl alcohol in water at 70 to 80° C. for several hours. The resulting homogeneous solution is then film cast. Due to the water solubility of this chelating agent, it was not necessary to react initially the chelating agent to increase its solubility. The resulting film had a thickness of 5 to 40 mils.

### Example II

The ability to reduce migration of a cathode metal ion was demonstrated for a separator formed of β-cyclodextrin-epichlorohydrin polymer blended with styrene sulfonate-acrylic acid polymer using the method described in Example I above. The separator with a ratio of PAA:PSS:CD in 15:50:35 was mechanically clamped into a diffusion test fixture, between two compartments of 9 M KOH, a highly alkaline solution. A first compartment, analogous to an electrolyte-soluble Bi₂O₃ cathode, contained saturated Bi⁺³ in solution and the second contained no Bi⁺³ initially. Measurement of the Bi⁺³ concentration in each compartment over time and comparison to the same experiment with styrene sulfonate-acrylic acid alone provided a relative indication of selectivity. An aliquot quantity of the solution from each compartment was taken out for Bi³⁺ concentration measurement over a period of several weeks. The addition of polymerized β-cyclodextrin reduced the migration of Bi³⁺ by almost 50% in a three-to-five day period.

Example III This example demonstrated the intermixing of an EDTA-derivative chelating agent with a polymer. A film of physically immobilized chelating agent, HEDTA, was prepared according to the following procedure:

(1) Ingredients were combined in the following order and mixed slowly to reduce trapped air bubbles:

1 g HEDTA (as a fine powder),
4 g polyvinyl alcohol solution (7.5 wt. % in water),

### 1 g of 1 M KOH.

The components were manually mixed with a laboratory stirring rod (˜0.5 cm diameter) at 20 ° C. at roughly 20 rpm.

(2) The resulting thick mixture was cast as a film and stored at room temperature (21 ° C.) overnight. The film was approximately 30-mil thick and white opaque with visible immobilized but undissolved fine particulates of HEDTA.

### Example IV

In this example, the chelating agent is not immobilized in a separator. This example, however, demonstrates the ability of HEDTA (a derivative of EDTA) to capture metal ions in highly alkaline solutions at 5 M and possibly 9 M KOH.

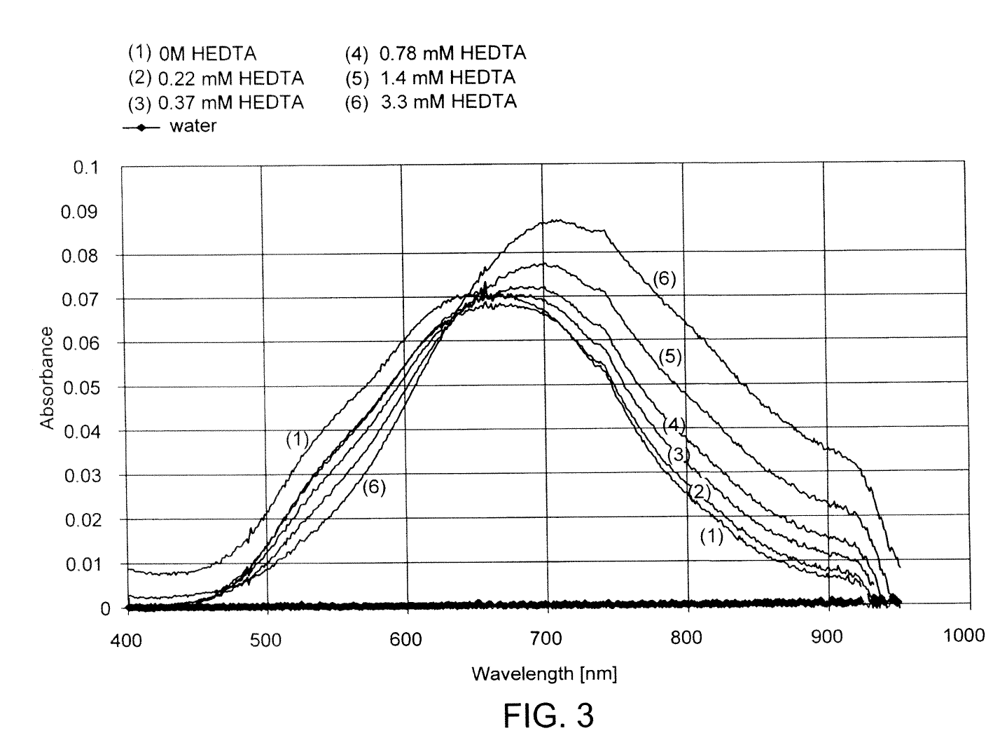

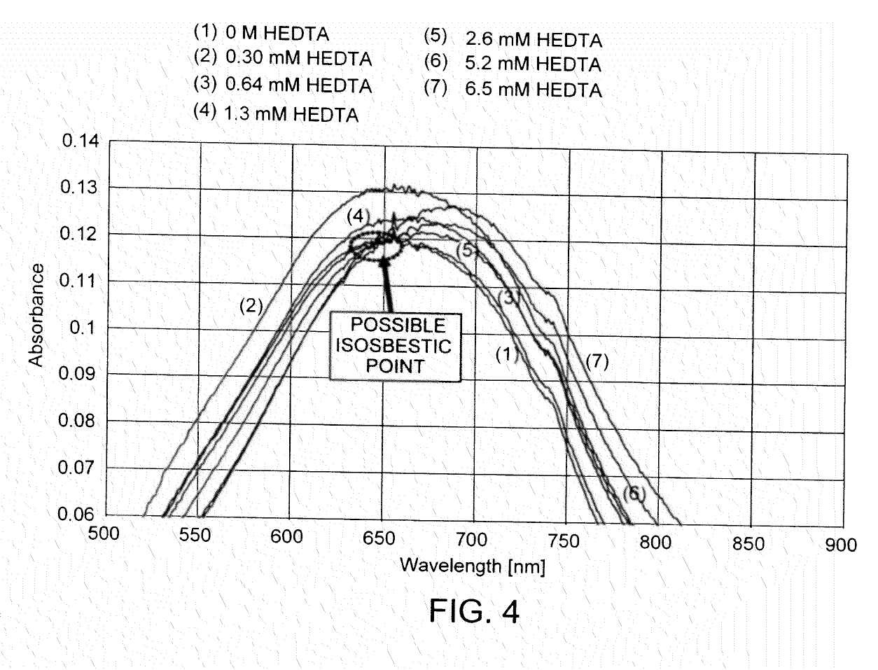

Detection of Cu²⁺ chelation with HEDTA was performed in solutions of approximately 1, 5, and 9 M KOH concentration respectively. First, 9 M KOH was prepared and saturated with Cu⁺² (as CuO). A Thermo Electron Intrepid II XSP Inductively Coupled Plasma (ICP) spectrometer was used to measure Cu⁺² concentration. Then, approximately 1 M and 5 M KOH mixtures were prepared by dilution. Finally, β-cyclodextrin and HEDTA were dissolved into samples of each KOH molarity to produce the compositions indicated in the captions of FIGS. 2-4. The chelation determination was performed using ultraviolet-visible (UV-Vis) light spectrophotometer, an Agilent 8453 System with 1-cm quartz cuvette. As the spectra shifts with increasing amounts of a chelating agent, a wavelength of common absorbance (isosbestic point) indicates successful chelation as demonstrated in FIG. 2 (0.9 M KOH) and FIG. 3 (5.1 M KOH) for HEDTA. For instance, in the 5 M KOH case, the ratio of Cu:HEDTA concentration ranged from 8.6 to 0.58. In 9 M KOH, chelation is hinted with a possible isosbestic point (cf. FIG. 4). The relatively high Cu²⁺ concentration may have approached the limit of applicability of the analysis with UV-Vis light spectroscopy.

### Other Embodiments

A number of embodiments of the invention have been described. Nevertheless, it will be understood that various modifications may be made without departing from the spirit and scope of the invention.

For example, other chelating agents may be used. Moreover, the chelating agent may be incorporated using techniques other than those described above.

In addition, any desired materials, including any of the materials and layers conventionally used in battery separator, may be used in combination with the ion selective layers described herein. Furthermore, the separator can have any of the designs typically used for primary alkaline battery separators.

For example, in some embodiments, the separator can include layers of a non-woven, non-membrane material, e.g., two layers of non-woven, non-membrane material each having a basis weight of about 54 grams per square meter, a thickness of about 5.4 mils when dry and a thickness of about 10 mils when wet. The layers can be substantially devoid of fillers, such as inorganic particles. In some embodiments, the separator can include inorganic particles.

In other embodiments, the separator can include an outer layer of cellophane and one or more layers of non-woven material. The cellophane layer can be adjacent to the cathode.

Accordingly, other embodiments are within the scope of the following claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A battery separator comprising:
two nanoporous layers, and
a chelating layer between the two nanoporous layers,
wherein the chelating layer comprises a chelating agent capable of forming a complex with cathodic metal ions.

2. The battery separator of claim 1, wherein the two nanoporous layers have pores larger than a size of hydrated hydroxide ion and smaller than a size of the chelating agent and complex.

3. The battery separator of claim 1, wherein the chelating agent comprises a cyclodextrin.

4. The battery separator of claim 1, wherein the chelating agent comprises a derivative of EDTA.

5. The battery separator of claim 4, wherein the EDTA derivative is selected from the group consisting of CDTA, HEDTA, TTHA, EGTA, DTPA, NTA, and mixtures thereof.

6. The battery separator of claim 5, wherein the EDTA derivative is HEDTA.

7. The battery separator of claim 1, wherein a concentration of chelating agent in the polymeric film is at least 0.1 μg per square centimeter of geometric surface area of the battery separator.

8. The battery separator of claim 1, wherein:
the battery separator comprises a slurry, solution, or suspension; and
the slurry, solution or suspension comprises the chelating agent in a carrier.

9. A method of making a battery separator comprising:
disposing a chelating-agent-containing layer between two nanoporous layers.

10. The method of claim 9, further comprising forming the chelating layer by forming a solution, dispersion or slurry of a chelating agent in a carrier
